(19) United States
(12) Patent Application Publication
(10) Pub. No.: US 2015/0072045 A1
(43) Pub. Date: Mar. 12, 2015

(54) SYSTEM AND METHOD FOR PRODUCTION OF CLARIFIED CITRUS JUICE CONCENTRATES CONTAINING 100% JUICE

(71) Applicants: Richard Lee Rice, Edgerton, WI (US); Markus A. Eckert, South Barrington, IL (US)

(72) Inventors: Richard Lee Rice, Edgerton, WI (US); Markus A. Eckert, South Barrington, IL (US)

(73) Assignee: ZENBURY INTERNATIONAL LIMITED, Tralee (IE)

(21) Appl. No.: 14/472,710

(22) Filed: Aug. 29, 2014

Related U.S. Application Data
(60) Provisional application No. 61/874,763, filed on Sep. 6, 2013.

(51) Int. Cl. A23L 2/06; A23L 2/84; A23L 2/78; A23L 2/80; A23L 2/08; A23L 2/74

(52) U.S. Cl. CPC A23L 2/06; A23L 2/085; A23L 2/74; A23L 2/78; A23L 2/80; A23L 2/84; A23V 2002/00
USPC 426/50; 426/599; 426/51

(57) ABSTRACT

A system and method for producing clarified citrus juice concentrates from various natural components of the respective fruit. Citrus peels and/or flesh segments are enzymatically digested to improve yield and facilitate clarification and concentration. The resulting juice concentrates contain no additives or preservatives. Said concentrates have no FDA Standards of Identity, and can be used in percentage juice calculations.

### CROSS-REFERENCE TO RELATED PATENT APPLICATIONS

This patent application claims the benefit of U.S. Provisional Patent Application No. 61/874,763, filed Sep. 6, 2013, the entire teachings and disclosure of which are incorporated herein by reference thereto.

### FIELD OF THE INVENTION

This invention generally relates to beverages such as juice beverages, and more particularly to juice concentrates for such beverages.

### BACKGROUND OF THE INVENTION

The trend toward healthy foods and beverages have led consumers away from products containing high fructose corn syrup and other refined sweeteners and more toward healthy alternatives such as fruit and vegetable juices. Several successful complete beverage lines currently make up a large segment of the juice and premium juice categories. Schools have eliminated high sugar containing beverages like those found in the major soft drink brands and have instead replaced those offerings with fruit juice containing products. Popular choices of juices include Apple and White Grape Juice from Concentrate. When these juices are combined with other flavorings juice blends, they help to fulfill juice percentage requirements while also presenting a relatively bland flavor profile that allows characterizing juices such as pomegranate and blueberry to be added to present a more complex and palatable overall flavor.

In the context of fruit juice, or fruit juice containing products, it is quite typical to employ the use of fruit juice concentrates in their manufacture. Such juice concentrates present a concentrated form of the juice component required to manufacture juice beverages. They are typically concentrated for purposes of shipment and storage and then utilized in the production of the juice beverage at a later point in time.

Unfortunately, the aforementioned increased demand for healthier drinks such as fruit juice beverages has also increased the demand for the aforementioned juice concentrates. There has been a difficulty in satisfying this increased demand for fruit juice concentrates. In the past decade the domestic production of apple juice concentrate has decreased almost to the level of non-existence. Over 400,000 metric tons of 70 degree Brix apple concentrate is imported into the US every year. The apple juice concentrate price has increased over 260% in the same time period. White grape juice concentrate has also consistently increased in price in the recent past. Due to demand, climate and political intervention in crop establishment, the white grape concentrate price has recently more than doubled.

The occurrences in the apple and grape markets noted above have led to a need in the art for an alternative bland juice concentrate and method for production thereof

The invention provides such a juice concentrate and method for production thereof These and other advantages of the invention, as well as additional inventive features, will be apparent from the description of the invention provided herein.

### BRIEF SUMMARY OF THE INVENTION

It is therefore one object and advantage of the present invention to produce a clarified citrus juice concentrate from peels and flesh that is viewed to contain 100% juice and contains no additives or preservatives.

It is another advantage of the invention that this clarified citrus juice concentrate can be used in food and beverage development.

In accordance with the foregoing objects and advantages, the present invention provides a clarified citrus juice concentrate, herein referred to as just clarified citrus juice concentrate, which provides an alternative to both apple and white grape concentrates in 100% juice beverages , drinks and foods.

In a preferred embodiment of the present invention, the clarified citrus juice concentrate is produced utilizing enzymes, water and molecular sieves.

In one aspect, a natural ingredient for use in food and beverages is provided that includes a clarified citrus juice concentrate produced from one or more of citrus peels of a citrus fruit and flesh of the citrus fruit. The clarified citrus juice concentrate was digested with naturally occurring enzymes. In certain embodiments, the clarified citrus juice exhibits a minimum of 60% transmittance at 440 nm when tested at 16 degrees Brix, and exhibits a maximum of about 5 nephelometric turbidity units when tested at 16 degrees Brix.

In certain embodiments, the citrus juice concentrate has been concentrated to between about 67 degrees Brix and about 69 degrees Brix. The concentration may exhibit a minimum of about 0.60% to a maximum of about 2.50% titratable acidity as citric acid when measured at 68 degrees Brix and may have a pH value between between about 2.5 and about 4.4

In another aspect, a method of manufacturing an ingredient for use in food and beverages is provided that includes the steps of providing a solid composition comprising one or more of citrus peels of a citrus fruit and flesh of the citrus fruit, grinding and steam injecting the solid composition to form a slurry, adding water to and cooling the slurry, adding enzymes to the slurry and allowing time for liquefaction, separating slurry to remove solids from a liquid of the slurry, filtering the liquid, removing off flavors and colors from the filtered liquid, and concentrating the finished juice.

In certain embodiments, the enzymes comprise a mixture of pectinases, cellulases, arabinase and other side activities. Preferably, the enzymes comprise an amount of no more than 2.0% w/w and no less than 0.002% w/w of the solid composition.

In certain embodiments, the solids of the slurry are separated from the liquid of the slurry by centrifugation or by pressing, and the liquid after separation comprises water and one or more of liquefied peel juice and flesh juice. The step of filtering may include filtering the liquid through an ultrafiltration membrane with a molecular weight cutoff of no less than 1,000 and no more than 200,000 Dalton units. The off flavors and colors may be removed by ion exchange resins and adsorbents. The step of concentrating the finished juice may include the removal of water by vacuum distillation and reverse osmosis.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a flow chart of an embodiment of a process for producing a clarified citrus juice concentrate according to the teachings of the present invention; and

FIG. 2 is an exemplary embodiment of a molecular sieve system for carrying out a portion of the process schematically presented in FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

All references to percentages herein are to percentages by weight unless otherwise indicated. The clarified citrus juice concentrates of the present invention are formed by the combination of two main ingredients, namely the peel of citrus sinensis, or citrus reticulata (preferably citrus sinensis), or citrus paradisi, citrus unshiu, citrus limon, or citrus aurentifolea and an organic solvent (preferably water). As discussed below, processing aids may be added to the clarified citrus juice depending upon the application.

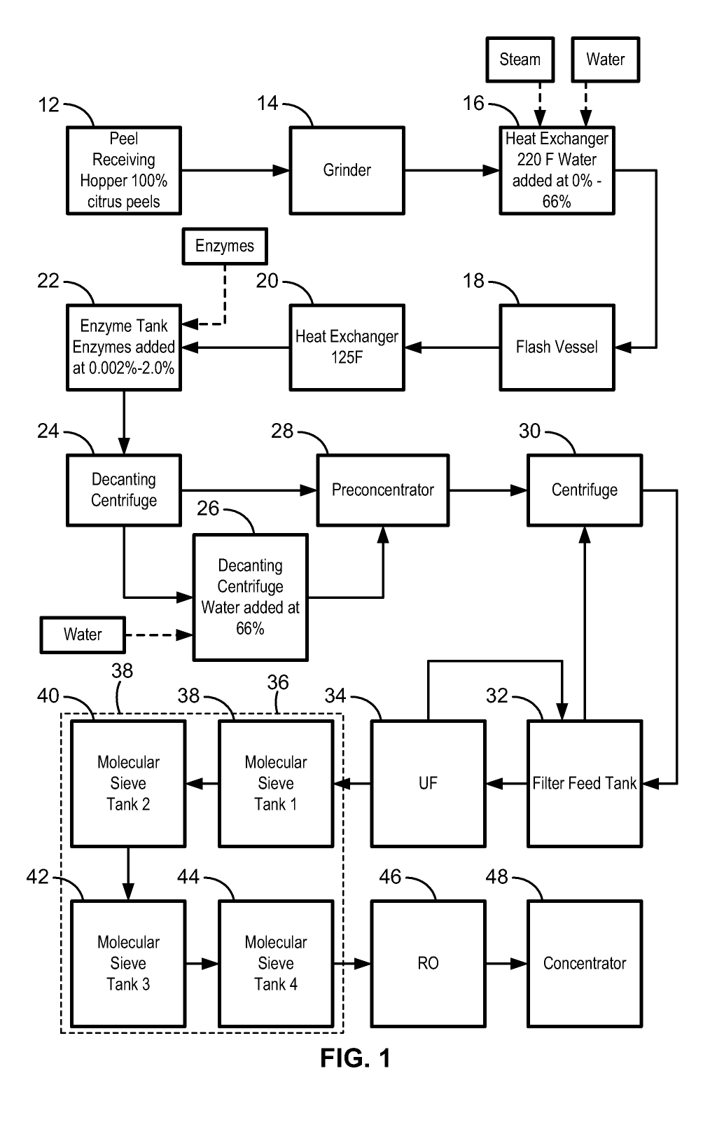

Turning now to FIG. 1, embodiments of the present invention comprise either a dried or non-dried mixture of peels and flesh of the aforementioned citrus fruits and water. In a preferred embodiment, a clarified citrus juice of between one and fifteen parts water to one part of plant material is provided. The amount of organic solvent needed varies in direct relationship to the viscosity of the plant/water slurry. It should be recognized by those of skill in the art that the ratio of soluble juice solids extracted from the plant material will remain the same in the permeate of the present invention if concentrated, dried or diluted.

The aforementioned peels are placed into a peel receiving hopper 12. The aforementioned step may be performed after juice extraction. In other words, the peels placed into peel receiving hopper 12 may be a by-product of another process, such as juice extraction or the like. The ratios of peel can be unlimited regarding the source being from any type of orange, lemon, lime or grapefruit. Whole citrus fruit and segments of any nature may also be added at any ratio.

The raw materials are then ground in a grinder 14 and heated in a heat exchanger 16. The final temperature can be about 110° F. up to about 220° F. or higher based on the discretion of the operator. Water and/or steam are added to heat exchanger 16 to form a slurry and disrupt cell wall integrity. This amount of steam and water may be added in amounts of preferably about 1% to about 300%, as well as higher amounts if necessary.

The slurry is then cooled to about 100° F. to about 130° F. by atmospheric flashing, vacuum flashing, and/or indirect heat exchange with a cooling medium in flashing vessel 18 or heat exchanger 20. The product is then treated with enzymes for a minimum of 15 minutes in enzyme tank 22. These enzymes may be added either singly or in combination at concentrations from 0.002% up to 2.000%. Examples of such enzymes added are pectinases, amylases, cellulases, carbohydrases, lypases, arabinases, and/or anthocyanases. The addition of organic acid(s) such as citric to adjust the pH into the range of 2.5 to 4.4 may also be provided at this stage. Additionally or in the alternative, the aforementioned acids may be added prior to this stage as well. Water is also added at concentrations from 1.0% up to about 15.0% at this stage.

The material is then pressed or preferably centrifuged in a decanting style centrifuge 24 whereby the liquid is discharged to a pre-concentrator 28 or directly to a higher speed centrifuge 26, normally in a vertical configuration. The solids discharge from the “decanting style” or initial centrifuge 24 is mixed with water and centrifuged again in centrifuge 26 whereby the solids are discharged for waste, animal feed or other further processing, and the liquid is combined with the liquid from the primary decanting centrifuge 24 and passed to pre-concentrator 28.

After leaving the pre-concentrator 28 the liquid is then sent through a third centrifuge 30 and then to a filter feed tank 32. Repeated passes through centrifuge 30 may also be conducted. Additionally, the extraction of the liquid phase from the solid phase can be carried out by utilizing a press in the alternative to centrifugation by centrifuges 24, 26, 30. The thoroughly centrifuged or pressed liquid is then passed through a filter 34, preferably a ultra filter (UF) 34, or micro filter, however other filtration media may be acceptable based on final product turbidity and shelf stability. Filter 34 present a molecular weight cutoff of no less than 1,000 and no more than 200,000 Dalton units. Additionally the liquid may be recirculated from filter 34 back to filter feed tank 32.

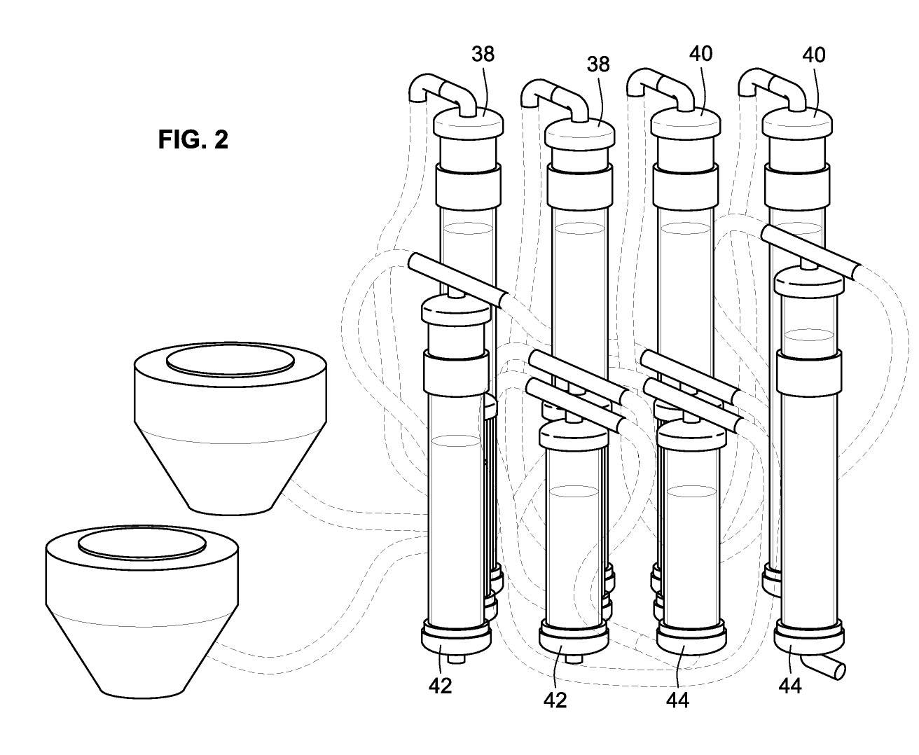

The filtered product is then passed through a novel and inventive molecular sieve system 36 according to the teachings of the invention comprised of adsorption, and ion exchange media. The system may comprise four separate tanks (or banks of tanks) 38, 40, 42, 44. Tank(s) 38 may contain a weak base resin while tank(s) 40 may contain adsorption media while tanks 42,44 may contain strong acid exchange media in either the same or various forms of cationic availability. For example, compounds used in the aforementioned tanks may be styrene divinylbenzene, epoxy amine, polymeric phenols, green sand, and/or organic carbons. An embodiment of the aforementioned system is shown at FIG. 2.

Returning now to FIG. 1, the product is then subjected to a final concentration step, which comprises a reverse osmosis arrangement 46 and a membrane and or vacuum evaporation process in concentrator 48. Samples of a clarified citrus juice concentrate manufactured using the process described herein were found to have a Brix value of about 67° Bx to about 69° Bx, a pH value of about 3.1 to about 4.2, a titratable acidity of about 0.10% to about 0.60%, a turbidity of about equal to or greater than 10 NTU at 10.8° Bx, a light transmittance at 440 nm (color) of about 60% at 10.8° Bx, and zero or only trace alcohol insolubles.

In a preferred embodiment of the method of making the present invention, citrus peel was depectinized in an aqueous solution, centrifuged at 6,000 g force and passed through an ultrafiltration membrane with a molecular weight cutoff of approximately 150,000 Dalton units. The filtered juice was passed through a strong acid cation exchange resin, and followed by a molecular sieve. The resultant juice was concentrated and compared favorably to white grape juice concentrate.

Depending upon the application and the exact hue desired, processing aids can be added. A wide variety of aids may be used and the invention is not limited to the following examples and the examples provided should be treated as representatives of the types of aids that may be used in conjunction with the present invention. For example, gelatin or casienates may be used. Silica Sols and bentonite may be used in certain applications. Isinglass and egg white may be used if necessary for finished product quality. Activated carbon and bone char may be added as well.

The nature of these clarified citrus concentrates of the present invention allow for their use in foods and beverages as defined by the U.S. Food & Drug Administration (FDA). The clarified citrus juice concentrates of this invention also have shelf lives sufficient for use in flavor, drug and cosmetic applications.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A natural ingredient for use in food and beverages, comprising:
a clarified citrus juice concentrate produced from one or more of citrus peels of a citrus fruit and flesh of the citrus fruit.

2. The ingredient of claim 1, wherein said clarified citrus juice concentrate was digested with naturally occurring enzymes.

3. The ingredient of claim 1, wherein said clarified citrus juice exhibits a minimum of 60% transmittance at 440 nm when tested at 16 degrees Brix.

4. The ingredient of claim 1, wherein said clarified citrus juice concentrate exhibits a maximum of about 5 nephelometric turbidity units when tested at 16 degrees Brix.

5. The ingredient of claim 1, wherein said clarified citrus juice concentrate has been concentrated to between about 67 degrees Brix and about 69 degrees Brix.

6. The ingredient of claim 1, wherein said clarified citrus juice concentrate exhibits a minimum of about 0.60% to a maximum of about 2.50% titratable acidity as citric acid when measured at 68 degrees Brix.

7. The ingredient of claim 1, wherein said clarified citrus juice concentrate is has a pH value between between about 2.5 and about 4.4

8. A method of manufacturing an ingredient for use in food and beverages, comprising the steps of:
providing a solid composition comprising one or more of citrus peels of a citrus fruit and flesh of the citrus fruit;
grinding and steam injecting the solid composition to form a slurry;
adding water to and cooling the slurry;
adding enzymes to the slurry and allowing time for liquefaction;
separating slurry to remove solids from a liquid of the slurry;
filtering the liquid;
removal of off flavors and colors from the filtered liquid; and
concentrating the finished juice.

9. The method of claim 8, wherein the enzymes comprise a mixture of pectinases, cellulases , arabinase and other side activities.

10. The method of claim 9, wherein the enzymes comprise an amount of no more than 2.0% w/w and no less than 0.002% w/w of the solid composition.

11. The method of claim 8, wherein the solids of the slurry are separated from the liquid of the slurry by centrifugation or by pressing.

12. The method of claim 8, wherein the liquid after separation comprises water and one or more of liquefied peel juice and flesh juice.

13. The method of claim 8, wherein the step of filtering comprising filtering the liquid through an ultrafiltration membrane with a molecular weight cutoff of no less than 1,000 and no more than 200,000 Dalton units.

14. The method of claim 8, wherein the off flavors and colors are removed by ion exchange resins and adsorbents.

15. The method of claim 8, wherein the step of concentrating the finished juice includes the removal of water by vacuum distillation and reverse osmosis.
